(19) United States
(12) Patent Application Publication
(10) Pub. No.: US 2014/0108839 A1
(43) Pub. Date: Apr. 17, 2014

(54) LOG RECORD WRITING SYSTEM, DEVICE, METHOD, AND PROGRAM

(71) Applicant: Takashi Horikawa, Minato-ku (JP)

(72) Inventor: Takashi Horikawa, Minato-ku (JP)

(73) Assignee: NEC CORPORATION, Minato-ku, Tokyo (JP)

(21) Appl. No.: 13/638,286

(22) PCT Filed: Apr. 13, 2012
(86) PCT No.: PCT/JP12/02599

§ 371 Date: Dec. 23, 2013

(30) Foreign Application Priority Data
Apr. 15, 2011 (JP) 2011-091288

(51) Int. Cl. G06F 1/32

(52) U.S. Cl. CPC G06F 1/3234
USPC 713/323

(57) ABSTRACT

A log record writing system includes a log writing media 1, a log writing control unit 2 which manages writing operation of a log record according to a log sequence number which is sequentially increased and writes the log record in the log writing media, and a queue storing unit 3 which stores a queue used so as to select a process which is an object for the waking-up operation among the processes which are waiting for completion of writing the log record in a sleeping state, and keeps the entries, which are elements of the queue, including process information and log sequence operation of the log record is performed by the other process, the log writing control unit 2 stores the queue entry that sets the log sequence number and the first process information and puts the first process to be in a sleeping state, and when the log record is completely written, the log writing control unit 2 compares the log sequence number included in an entry stored in the queue with a log sequence number of the log record which is completely written to extract all processes which completely write the log record and wakes up the processes.

### TECHNICAL FIELD

The present invention relates to a log record writing system, a log record writing device, a log record writing method, and a log record writing program.

### BACKGROUND ART

Among information systems that store information in a file or a database, in an information system that requires particularly a high reliability, specifically, a system that does not allow information, which has been completely stored, to disappear, a method that writes information concerning a storing operation as a log record in a log writing media other than the file or the database is widely used. A database management system is a typical example of the above-mentioned information system. In this specification, hereinafter, an operation that stores information in a file or a database is referred to as “storing” and an operation that stores a log record concerning the storing operation in a log writing media is referred to as “writing” in order to distinguish “storing” from “writing”. An object of writing the log record is that when information stored in a file or a database is hardly read due to a system error, the storing operation is re-performed based on the log record written in the log writing media and the information of the file or the database is restored at the time of the system error.

Generally, in the information system, since a plurality of processes is concurrently performed, with respect to the storing to the file or the database, a plurality of storing operations is concurrently performed. Therefore, with respect to a log record generated by the storing operation, a plurality of log records is concurrently written. In this case, when characteristics of a device of writing a log are considered, efficiency when the plurality of log records is written all together is higher than efficiency when the writing operation is performed on individual log record. This is because it takes time from starting the writing operation for the writing device to starting the writing operation to a writing media in the writing device. In other words, an overhead may be applied for one writing operation. Therefore, when the writing operation is performed for every log record, the overhead is applied for every writing operation. In contrast, when the plurality of log records is written all together, overhead is applied for only one writing operation, which may reduce the overhead and increase efficiency.

When a plurality of processes is controlled to write the log record all together, when the writing operation is completed, completion of the log writing needs to be notified to the plurality of processes. As compared with a speed of a memory that stores data which are directly used by the processes, a speed of accessing the log writing media is several thousand times slower. Therefore, in many cases, the process is in a sleep state, in other words, the state when usage of the process is stopped and the completion of the log writing is waited. According to a sleep and wait mode, a processor may perform a processing of another process during the mode to improve the performance as a system. In this case, an operation that notifies the completion of log writing indicates an operation that wakes up the sleeping process, that is, changes the sleeping state into a state that performs the processing using a processor.

Generally, a log sequence number (hereinafter, abbreviated as an LSN) which is uniquely increased is attached to individual log record and the log writing operation is managed by the LSN. In other words, a completion of writing a log record having an arbitrary LSN means that writing of a log record having a smaller LSN than the arbitrary LSN is also completed. In other words, if a log writing operation for an LSN is completed, the writing operation for a log record having a LSN smaller than that is also completed. Therefore, it is necessary to perform the waking-up operation for a process that waits to write the log record. In contrast, a log record having a larger LSN than an LSN of the log record whose writing operation is completed may not be written. Therefore, it is required to control to obey that the waking-up operation for a process that waits completion of writing the log record should not be performed.

As for a technology with respect to the above description, for example, in Patent Literature 1, a method of storing a log file is disclosed. According to the method disclosed in Patent Literature 1, when a queuing means receives a log file storing request of a message from a plurality applications, a plurality of file I/O processing units extracts the messages in a predetermined order and stores the messages in a log file with which is associated in advance.

### CITATION LIST

### Patent Literature

PLT 1: Japanese Patent Application Laid-Open No. 07-271648

### SUMMARY OF INVENTION

### Technical Problem

A flow of a program that performs the above-mentioned control is illustrated in FIG. 10, which is a simplified format of a method that is used in PostgreSQL which is a database management system of an open source. A variable that may be referred to from all processes is a lock flag for achieving a lock in order to limit the number of processes that performs the writing operation to one, an LSN (completion LSN) in which writing is completed, and a maximum value (request LSN) within LSNs attached to each log record to be written.

In the processing illustrated in FIG. 10, if an arbitrary process needs to perform storing into a database and writing of a corresponding log record, first, the process tries to obtain a lock which is achieved by a lock flag (step 10-1). Here, when the lock may not be obtained, the lock release is waited in a sleeping state (step 10-7). The sleeping state is dissolved by performing the waking-up operation (step 10-6) when a process that obtains the lock releases the lock.

If the lock may be obtained in step 10-1, the process compares an LSN of a log record to be written by the process and a completion LSN (step 10-3). As a result, if the LSN of the log record to be written by the process is larger than the completion LSN, this indicates that it is required to perform an operation of writing log records. Therefore, the writing operation of the log records corresponding up to the request LSN is performed (step 10-4).

If the writing operation if step 10-4 is completed, the request LSN is set to a completion LSN (step 10-5) and then the writing operation lock is released (step 10-6) and then a series of flows is completed. Further, as a result of the comparing operation in step 10-3, when the LSN of the log record to be written by the process is smaller than or equal to the completion LSN, the writing operation lock is immediately released (step 10-6) and a series of flows is completed.

If a plurality of processes concurrently performs the flows, the followings are guaranteed: 1) the writing operation of a log record to be written by the processes is completed at the time of completion of the flows of the individual processes and 2) when the writing of the log record is not completed, the writing operation start. Further, depending on a system in step 10-4, the request LSN, that is, the maximum value in the LSNs attached to the log record to be written at that timing may not be obtained. In such a system, when the request LSN may not be obtained, the log to the LSN of the log record to be written by the process that obtains the lock is written in step 10-4.

FIG. 4 is a timing chart illustrating an example of an operation when a plurality of processes concurrently performs the flow. Specifically, an operation when a process that performs a transaction 2-1 writes log records of transactions 2-1 to 2-4 in a log writing media is illustrated.

As illustrated in FIG. 4, when the writing operation in the log writing media is completed, a process that processes the transaction 2-1 is woken up first. When the process resumes the operation, a process that processes the transaction 2-2 is woken up. When the process resumes the operation, a process that processes the transaction 2-3 is woken up. In this manner, every process is woken up one by one in this order.

FIG. 11 is a timing chart illustrating an operation when a process (a process of processing a transaction 3) that does not complete the log writing operation is woken up prior to a process (a process of processing a transaction 2-4) that completes the log writing operation when every process is sequentially woken up one by one. This drawing illustrates the case where the process of processing the transaction 2-4 resumes the operation when or after the log record 6 of the transaction 3 is completely written even though the operation is resumed at the time of completing the writing operation of log records 2, 3, 4, and 5.

There are problems when the control is performed as described above, if the log records of the plurality of processes are written all together, it takes time to perform the waking-up operation when the log record is completely written in the log storing media. This is because the waking-up operation of the processes needs to be successively performed. In other words, if the operation of writing the log records of the plurality of processes all together is completed, first, a process that performs the writing operation is woken up to resume the processing and one of processes which are waiting the completion of writing the log in a sleeping state is woken up. Next, in a process that is resumed by the woken-up process, one of the plurality of processes which is waiting the completion of writing the log record in a sleeping state at that timing is woken up. In the manner that a process that resumes the processing by the waking-up operation wakes up the next process, every process is sequentially woken up one by one. In other words, the waking-up operation is successively performed. Therefore, it takes time to complete the waking-up operation for all processes that may resume the processing by completing the log writing, that is, all processes to be woken up.

Further, the log record is completely written and a process which may essentially perform a next processing may be sleeping. This is because, at the time of completing the operation that writes the log record of the plurality of processes all together, when one of processes, which are waiting the completion of writing the log in a sleeping state, is selected to be woken up, if the selection is not proper, that is, in the state when a process in which the log is completely written and a process in which the log is not completely written are mixed, a process in which the log is not completely written may be selected to be woken up. If this process is selected, the selected process starts the log writing operation but does not perform the operation of waking up a process which is in the log writing waiting state until the completion of the log writing operation. Therefore, when the first process is selected, the log record is completely written and the process which may essentially perform the next processing is in the sleeping state during unnecessary period.

Further, the unit of the log writing operation may be fragmental, which may lower efficiency. This is because, when the log writing operation is performed, if a maximum value within the log sequence numbers attached to the log record to be written at that timing may not be obtained, not all log which may be written at that timing, but log records up to the log sequence numbers attached to the log records which are required to be written by the process that performs the writing operation are written.

An object of the present invention is to provide, in an information system that outputs a write concerning the storing operation as a log record in order to protect information which has been already stored from disappearing due to the system error in an information system that stores information into a file or a database, a log record writing system, a log record writing device, a log record writing method, and a log record writing program that can efficiently write the log record concerning storing operation performed by a plurality of processes all together through one storing operation.

### Solution to Problem

A log record writing system according to the present invention comprises a log writing media, a log writing control means which manages writing operation of a log record according to a log sequence number which is sequentially increased and writes the log record in the log writing media, and a queue storing means which stores a process waiting management queue which is used so as to select a process which is an object for the waking-up operation based on completion of writing the log record, among the processes which are waiting completion of writing the log record in a sleeping state, wherein the queue entries, which are elements of the process waiting management queue, includes information indicating the process in the sleeping state and the log sequence numbers corresponding to the information, and when a first process requests to write the log record and the writing operation of the log record is performed by the other process, with respect to the first process, the log writing control means stores the queue entry that sets the log sequence number and the information indicating the first process in the process waiting management queue and then allows the first process to be in a sleeping state and then when the log record is completely written, the log writing control means compares the log sequence number included in the queue entry with a log sequence number of the log record which is completely written with respect to the queue entry stored in the process waiting management queue to extract all processes which completely write the log record and wakes up all extracted processes that completely write the logs.

A log record writing device according to the present invention comprises a log writing media, a log writing control means which manages writing operation of a log record according to a log sequence number which is sequentially increased and writes the log record in the log writing media, and a queue storing means which stores a process waiting management queue which is used so as to select a process which is an object for the waking-up operation based on completion of writing the log record, among the processes which are waiting completion of writing the log record in a sleeping state, wherein the queue entries, which are elements of the process waiting management queue, includes information indicating the process in the sleeping state and the log sequence numbers corresponding to the information, and when a first process requests to write the log record and the writing operation of the log record is performed by the other process, with respect to the first process, the log writing control means stores the queue entry that sets the log sequence number and the information indicating the first process in the process waiting management queue and then allows the first process to be in a sleeping state and then when the log record is completely written, the log writing control means compares the log sequence number included in the queue entry with a log sequence number of the log record which is completely written with respect to the queue entry stored in the process waiting management queue to extract all processes which completely write the log record and wakes up all extracted processes that completely write the logs.

A log record writing method according to the present invention comprises: storing a process waiting management queue which is used so as to select a process which is an object for the waking-up operation based on completion of writing a log record, among the processes which are waiting completion of writing the log record in a sleeping state, and keeps the queue entries, which are elements of the process waiting management queue, including information indicating the process in the sleeping state and log sequence numbers which are sequentially increased and correspond to the information, when a first process requests to write the log record and the writing operation of the log record is performed by the other process, storing the queue entry that sets the log sequence number and the information indicating the first process in the process waiting management queue with respect to the first process and then allowing the first process to be in a sleeping state and then when the log record is completely written, comparing the log sequence number included in the queue entry with a log sequence number of the log record which is completely written with respect to the queue entry stored in the process waiting management queue to extract all processes which completely write the log record and waking up all extracted processes that completely write the logs.

A log record writing program according to the present invention including a storing means which stores a process waiting management queue which is used so as to select a process which is an object for the waking-up operation based on completion of writing a log record, among the processes which are waiting completion of writing the log record in a sleeping state, and keeps the queue entries, which are elements of the process waiting management queue, including information indicating the process in the sleeping state and log sequence numbers which are sequentially increased and correspond to the information, to execute: when a first process requests to write the log record and the writing operation of the log record is performed by the other process, storing the queue entry that sets the log sequence number and the information indicating the first process in the process waiting management queue with respect to the first process, allowing the first process to be in a sleeping state, when the log record is completely written, comparing the log sequence number included in the queue entry with a log sequence number of the log record which is completely written with respect to the queue entry stored in the process waiting management queue to extract all processes which completely write the log record, and waking up all extracted processes that completely write the logs.

### Advantageous Effects of Invention

According to the present invention, in an information system that outputs a write concerning the storing operation as log record in order to protect information which has been already stored from disappearing due to the system error in an information system that stores information into a file or a database, the log record concerning storing operation performed by a plurality of processes can be efficiently written all together through one storing operation.

### BRIEF DESCRIPTION OF DRAWINGS

FIG. 1 is a block diagram illustrating a configuration example of a first exemplary embodiment of a log record writing system according to the present invention.

FIG. 2 is a flowchart illustrating an operational example of a log writing control means according to the first exemplary embodiment.

FIG. 3 is a flowchart illustrating an operational example of a writing completion notifying means according to the first exemplary embodiment.

FIG. 4 is a timing chart illustrating an example of an operation when the log is completely written by a common technology.

FIG. 5 is a timing chart illustrating an operational example when the log is completely written according to the first exemplary embodiment.

FIG. 6 is a block diagram illustrating a configuration example of a second exemplary embodiment of a log record writing system according to the present invention.

FIG. 7 is a flowchart illustrating an operational example of a log writing control means according to the second exemplary embodiment.

FIG. 8 is a flowchart illustrating an operational example of a media writing completion notifying means according to the second exemplary embodiment.

FIG. 9 is a flowchart illustrating an operational example of a lock release notifying means according to the second exemplary embodiment.

FIG. 10 is a flowchart illustrating an operation of a log writing control means according to a common technology.

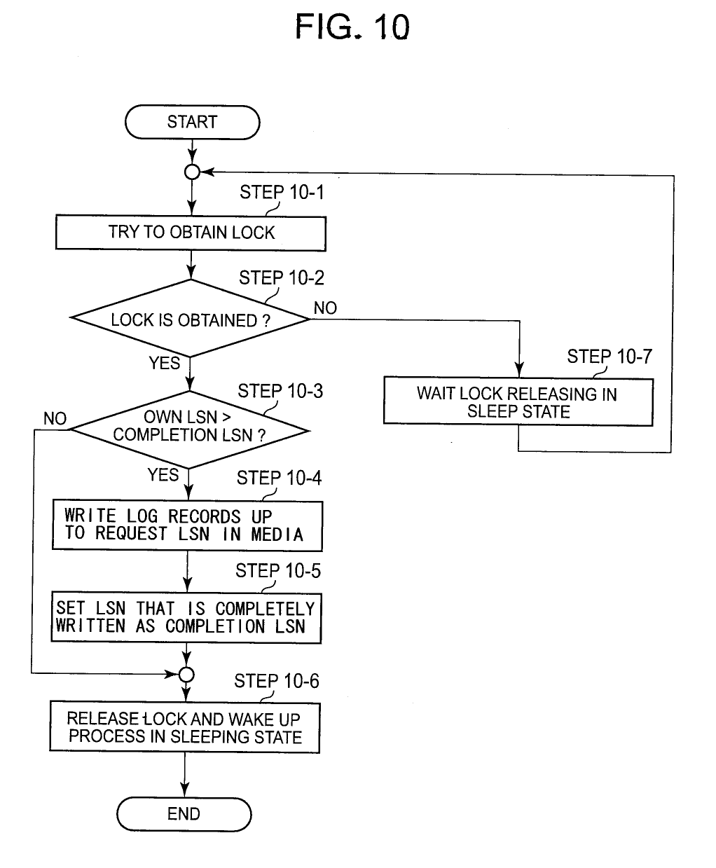

FIG. 11 is a timing chart illustrating an example of an operation in which resuming of an operation of a transaction processing process is delayed until the next log is completely written at the time of completion of writing the log by the common technology.

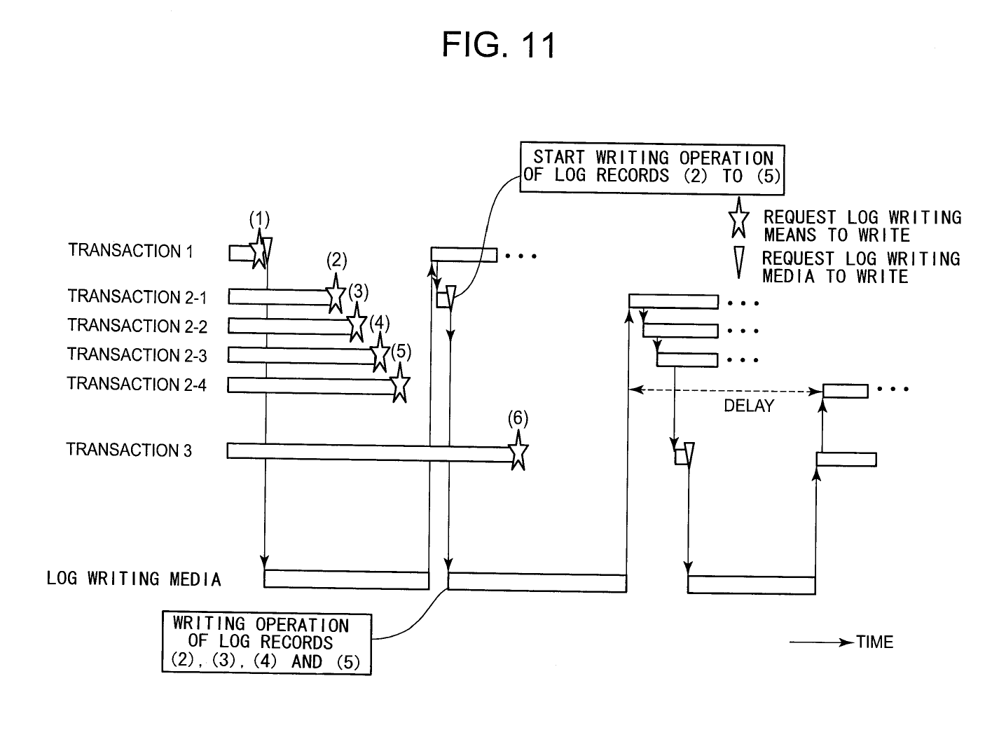

FIG. 12 is a block diagram illustrating a minimum configuration example of a log record writing system.

### DESCRIPTION OF EMBODIMENTS

### First Exemplary Embodiment

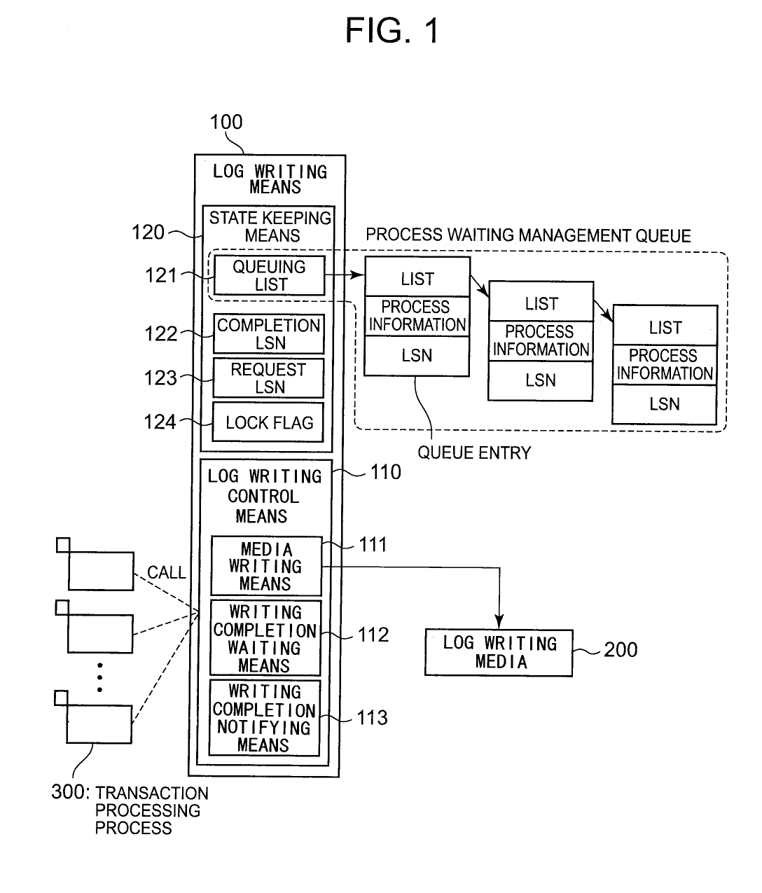

Next, a first exemplary embodiment of the present invention will be described with reference to the drawings. FIG. 1 is a block diagram illustrating a configuration example of a first exemplary embodiment of a log record writing system according to the present invention. Referring to FIG. 1, in the first exemplary embodiment, the log record writing system includes a log writing means 100 including a log writing control means 110 and a state keeping means 120 and a log writing media 200. Further, in the log record writing system, the processing may be performed in accordance with a plurality of transaction processing processes 300.

The log writing means 100, specifically, is implemented by an information processing device such as a personal computer that operates in accordance with a program. Further, the log writing media 200, specifically, is implemented by a storing device such as a magnetic disk device or an optical disk device. Further, the transaction processing process, specifically, is implemented by being processed by a CPU of the information processing device in accordance with the program.

The state keeping means 120 includes a queuing list 121, a completion LSN 122, a request LSN 123, and a lock flag 124. Specifically, the state keeping means 120 stores the data. The log writing control means 110 includes a media writing means 111, a writing completion waiting means 112, and a writing completion notifying means 113.

The above means are roughly operated as described below.

The state keeping means 120 has a function to store values received from a request source in variables of the queuing list 121, the completion LSN 122, the request LSN 123, and the lock flag 124 in accordance with the storing request from other means. Further, the state keeping means 120 has a function to extract the values stored in the variables to be output to the request source in accordance with the reading request of information from other means.

Among the variables, the queuing list 121 is a variable that keeps a pointer for forming a linked list structure having a queue entry as an element. Further, the completion LSN 122 and the request LSN 123 are variables that store the LSNs. Further, the lock flag 124 is a variable that stores two kinds of values that are locked or unlocked.

A queue entry is a data structure for writing information concerning a sleeping process. The queue entry includes three kinds of variables, that is, a pointer to other queue entry used to form the linked list structure together with the queuing list variable, process information for specifying a sleeping process, and an LSN. Data having a linked list structure formed by the queuing list 121 and the queue entry is referred to as a queue for process waiting management.

The log writing control means 110 has a function to write a log in accordance with a request from the transaction processing process 300. The log writing control means 110, specifically, is implemented by a CPU of the information processing device that operates in accordance with a program.

The media writing means 111 has a function to perform operation of storing log records from a next LSN of the completion LSN 122 to a requested LSN in the log writing media 200.

It is assumed that, when the media writing means 111 performs the writing operation of a log record in accordance with the log writing request from a first transaction processing process 300, a second transaction processing process 300 performs the log writing request. In this case, the second transaction processing process 300 allows the writing completion waiting means 112 to wait the completion of the log record writing operation by the first transaction processing process 300. Further, when the log record is completely written, the first transaction processing process 300 allows the writing completion notifying means 113 to notify the completion of the log writing operation to the second transaction processing process 300. The details of the waiting processing and the completion notifying processing will be described below.

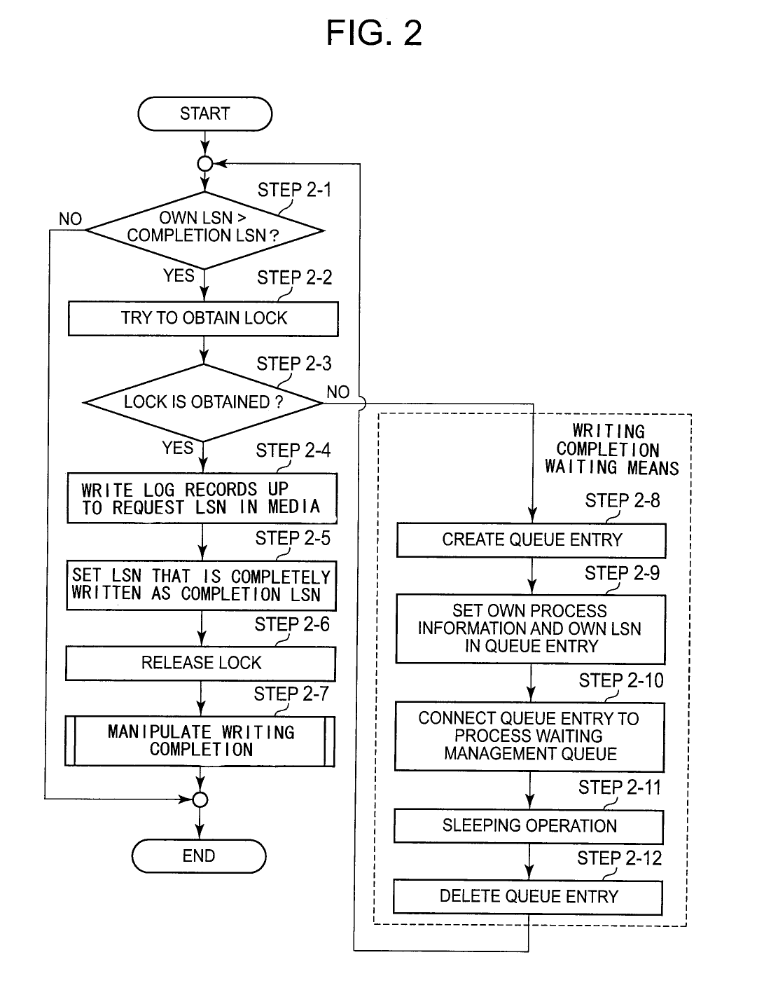

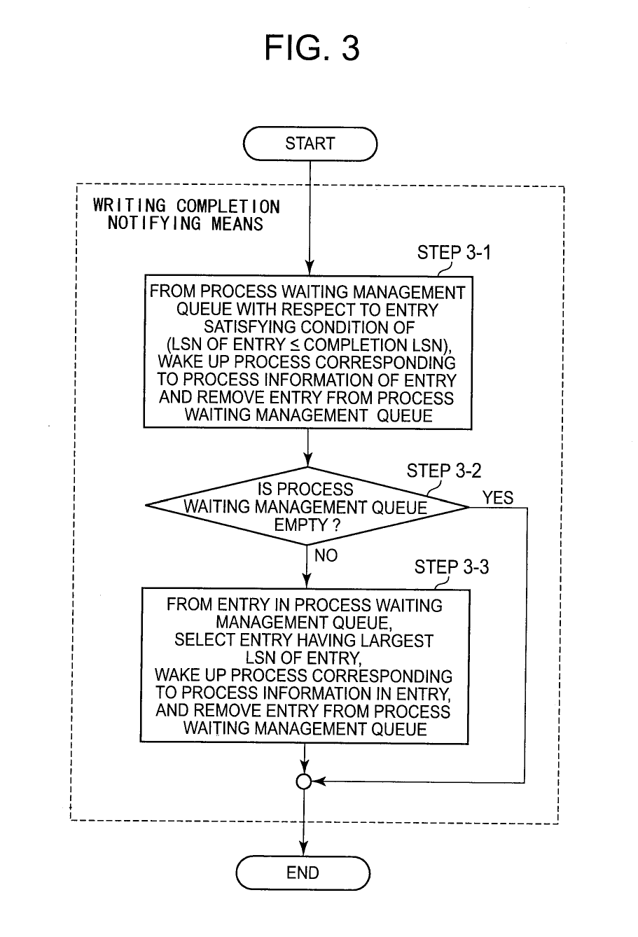

Next, referring to flowcharts of FIGS. 2 and 3, the entire operation of the present exemplary embodiment will be described. FIG. 2 is a flowchart illustrating an operational example of the log writing control means according to the first exemplary embodiment. FIG. 3 is a flowchart illustrating an operational example of the writing completion notifying means according to the first exemplary embodiment.

First, the transaction processing process 300 that requests to write a log creates information of the log to be written. The transaction processing process 300 updates the request LSN 123 and associates the updated request LSN 123 with the log record and then starts the log writing control means 110. For example, the transaction processing process 300 associates the updated request LSN 123 with the created log record as a log writing request to output to the log writing control means 110.

The operations so far are the same as the treatment of the log record by a common technology. Hereinafter, the LSN which is associated with the log record created by the above-mentioned transaction processing process 300 is referred to as “own LSN” which means that the LSN is the LSN of the transaction processing process 300.

The log writing control means 110 compares the own LSN with the completion LSN 122 (step 2-1 of FIG. 2). As a comparison result, if it is determined that the own LSN is equal to or smaller than the completion LSN 122, this case indicates that the log record is completely written in the log writing media 220, and thus the log writing control means 110 completes the log writing operation.

In contrast, if it is determined that the own LSN is larger than the completion LSN 122, the log writing control means 110 tries to obtain a lock which is managed by the lock flag 124 in the state keeping means 120 (step 2-2) and confirms whether to succeed in obtaining the lock (step 2-3).

A case when the lock obtaining operation fails to obtain the lock, that is, the lock has been already obtained by other transaction processing process 300 will be described. This case indicates that the transaction processing process 300 that has obtained the lock performs the writing operation in the log writing media 200. Therefore, the transaction processing process 300 which fails to obtain the lock waits the completion of the writing operation to the log writing media 200 by the writing completion waiting means 112.

Specifically, the writing completion waiting means 112 creates a queue entry (step 2-8) and sets information of a own process (that is, the transaction processing process 300 that fails to obtain the lock) and the own LSN in the created queue entry (step 2-9). The writing completion waiting means 112 connects the queue entry to a process waiting management queue that manages data by a list structure (step 2-10). Hereinafter, even though an expression that the queue entry is connected to the process waiting management queue is used, specifically, the queue entry is stored in the process waiting management queue.

Further, in this exemplary embodiment, even though the queue entry is managed using data having a list structure which is a common technology, any data structure may be appropriately used.

After connecting the queue entry to the process waiting management queue, the writing completion waiting means 112 performs a sleeping operation on the transaction processing process 300 (step 2-11). The sleeping state is continued until the transaction processing process 300 is woken up by the writing completion notifying operation by the other transaction processing process 300, as described below.

After the sleeping transaction processing process 300 wakes up and resumes the processing, the writing completion waiting means 112 deletes an unnecessary queue entry (step 2-12). Thereafter, the log writing control means 110 performs the processing again from the first step (step 2-1) of the log writing operation.

In the meantime, a case when the lock is successfully obtained by the lock obtaining operation of step 2-2 will be described. This case indicates that there is no other transaction processing process 300 that performs the writing operation to the media. Therefore, the transaction processing process 300 that successfully obtains the lock allows the media writing means 111 to perform the operation that writes the log records to the request LSN 123 in the log writing media 200 (step 2-4). Specifically, in accordance with the log writing request output from the transaction processing process 300, the media writing means 111 performs the operation that writes log records from the next of the completion LSN 122 to the request LSN 123 in the log writing media 200.

When the writing in the log writing media 200 is completed, the log writing control means 110 sets an LSN that is requested to the media writing means 111 in step 2-4, that is, the LSN corresponding to the log record that is completely written as the completion LSN 122 (step 2-5).

Next, the log writing control means 110 releases the lock (step 2-6). The transaction processing process 300 allows the writing completion notifying means 113 to wake up another transaction processing process 300 which waits the completion of writing the log record by a writing completion notifying operation (step 2-7).

Specifically, the writing completion notifying means 113 first selects all queue entries that satisfy the condition that the LSN of the queue entry is equal to or smaller than the completion LSN 122, among the queue entries which are connected to the process waiting management queue. The writing completion notifying means 113 controls to notify the writing completion to the transaction processing process 300 that corresponds to the process information in the selected queue entries to be woken up. Thereafter, the writing completion notifying means 113 removes the selected queue entry from the process waiting management queue (step 3-1 of FIG. 3).

After completing the operation of step 3-1, the writing completion notifying means 113 checks whether a queue entry remains in the processing waiting management queue (step 3-2).

When the queue entry remains, the writing completion notifying means 113 selects a queue entry having the largest LSN among the queue entries connected to the process waiting management queue. The writing completion notifying means 113 controls to notify the writing completion to the transaction processing process 300 corresponding to the process information in the selected queue entry to control the transaction processing process 300 to be woken up. Thereafter, the writing completion notifying means 113 removes the selected queue entry from the process waiting management queue (step 3-3).

Next, an effect of the exemplary embodiment will be described. In this exemplary embodiment, when the plurality of transaction processing processes 300 waits the completion of writing the log record in a sleeping state, the writing completion notifying means 113 selects all entries that satisfies the condition that the LSN of the queue entry is equal to or smaller than the completion LSN 122. The writing completion notifying means 113 is configured to wake up the transaction processing process 300 corresponding to the process information in the selected waiting entries. Therefore, all transaction processing processes 300 that completely write the log record may be woken up by one writing completion notifying operation.

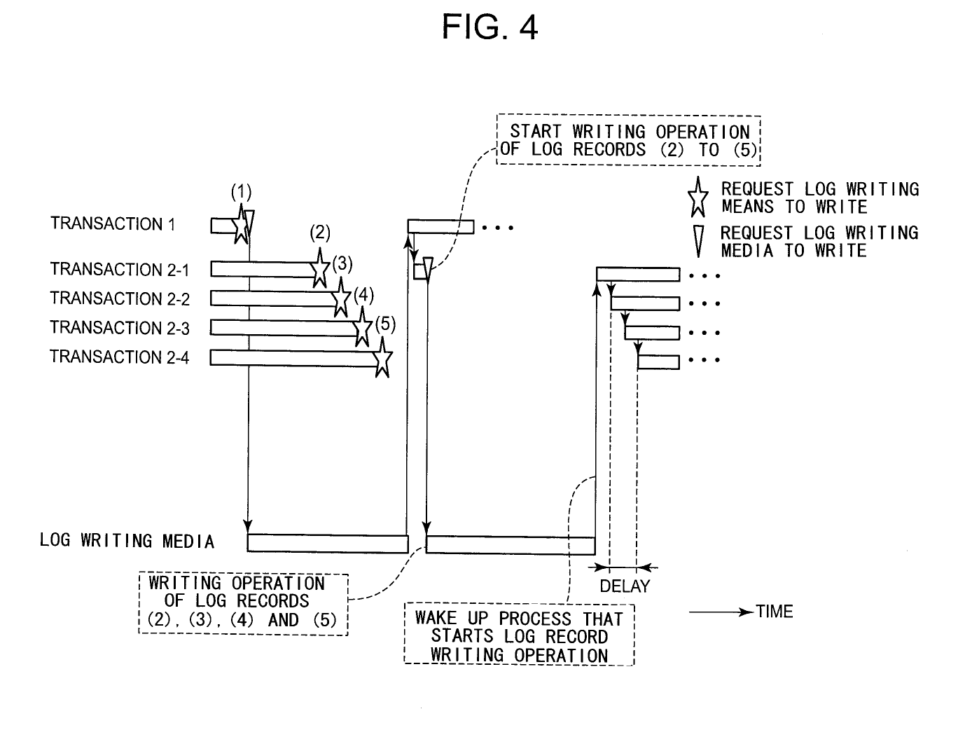

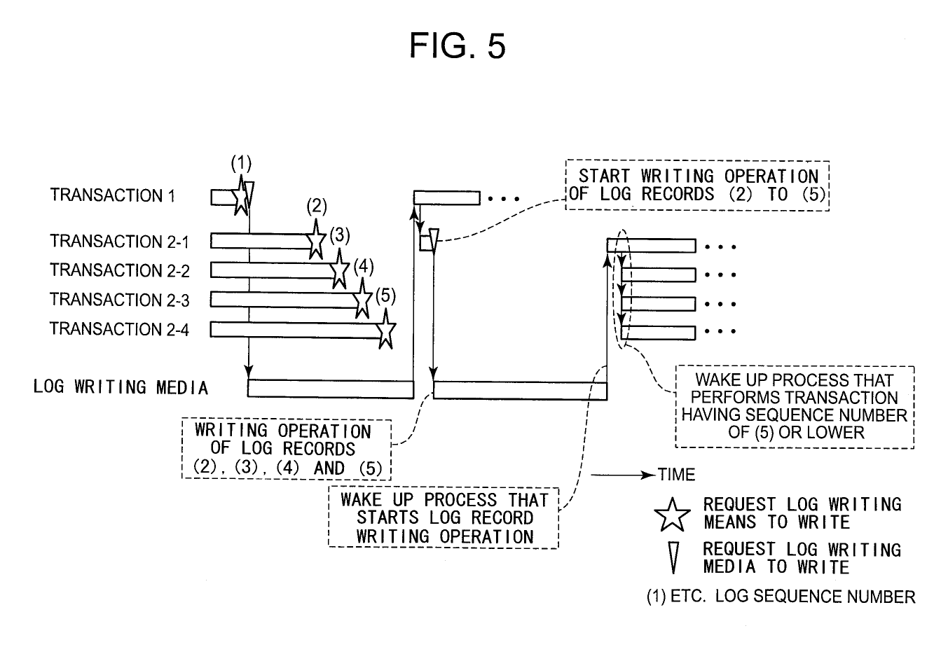

Specifically, in the common technology, as illustrated in FIG. 4, when the process of processing the transaction 2-1 requests to write the log record of a plurality of processing processes 300 (in FIG. 4, transactions 2-1 to 2-4) in the log writing media 200, first, the process of processing the transaction 2-1 is woken up. Then, the process of processing the transaction 2-1 wakes up the process of processing the transaction 2-2. Further, the process of processing the transaction 2-2 wakes up the process of processing the transaction 2-3. In this manner, the waking-up operation is performed through each transaction processing process 300. To the contrary, in this exemplary embodiment, as illustrated in FIG. 5, the process of processing the transaction 2-1 may wake up the processes of processing the transactions 2-2 to 2-4 which completely write the log.

Further, in this exemplary embodiment, the writing completion notifying means 113 wakes up all transaction processing processes 300 that completely write the log, and then if a queue entry remains, selects the queue entry having the largest LSN among the queue entries which are connected to the process waiting management queue. The writing completion notifying means 113 is configured to wake up the process corresponding to the process information in the selected queue entries.

Therefore, in the next log writing operation, corresponding log records up to the largest request LSN 123, at the time of operating the writing completion notifying means 113, may be a writing object.

Accordingly, in this exemplary embodiment, when the operation of writing the log records of the plurality of processes in the log storing media is completed, the time until the waking-up operation is performed may be shortened. This is because a plurality of processes which are set to entries, each entry having a log sequence number which is equal to or smaller than a log sequence number whose writing is completed becomes objects for waking-up.

Further, in this exemplary embodiment, when the operation of writing the log records of the plurality of processes in the log storing media is completed, it is possible to control to perform the waking-up operation for all processes that completely write the log record. This is because the process that waits the completion of log writing operation connects an entry that sets the information of the log sequence number and information of the own process to the queue so as to select the entries having the number which is equal to or smaller than a log sequence number whose writing is completed without omission when selecting the process which is an object for waking-up.

Further, in this exemplary embodiment, the unit of the log writing operation may be maximized. This is because the process that waits the completion of the log writing operation connects an entry that sets the information of the log sequence number and information of the own process to the queue, and thus other than the process that completely writes the log, among the processes that do not completely write the log, a process having the largest log sequence number may be selected as the object for waking-up.

As described above, according to this exemplary embodiment, in an information system that outputs a write concerning the storing operation as a log record in order to protect information which has been already stored from disappearing due to the system error in an information system that stores information into a file or a database, the log record concerning storing operation performed by a plurality of processes can be efficiently written all together through one storing operation.

### Second Exemplary Embodiment

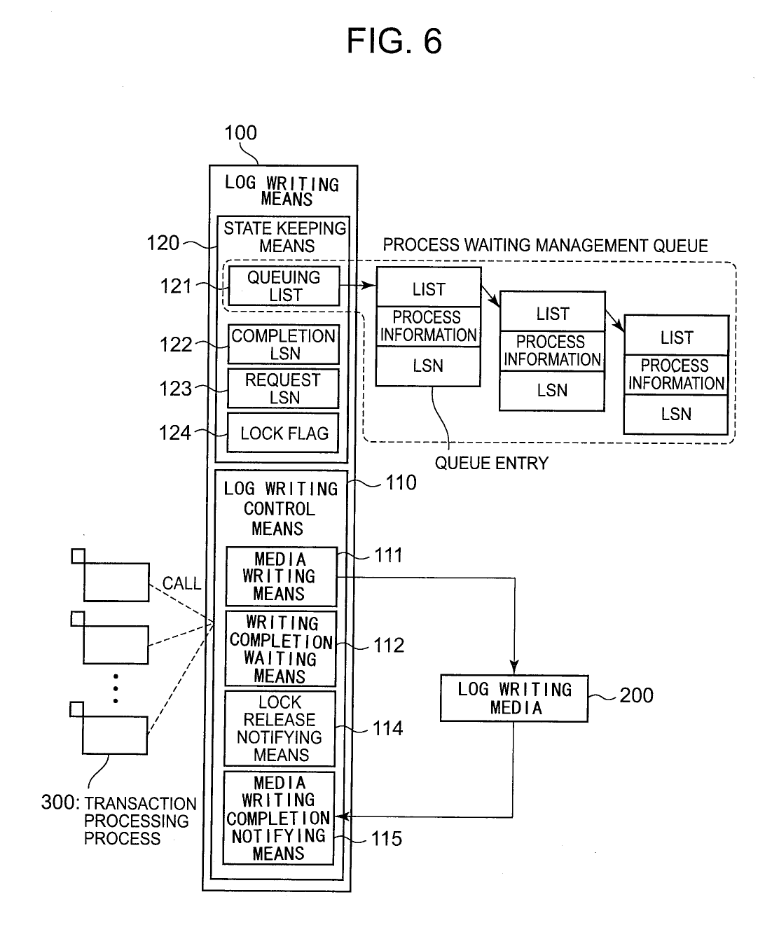

Next, a second exemplary embodiment of the present invention will be described with reference to the drawings. FIG. 6 is a block diagram illustrating a configuration example of a second exemplary embodiment of a log record writing system.

Referring to FIG. 1, in the exemplary embodiment, the log record writing system includes a log writing means 100 including a log writing control means 110 and a state keeping means 120 and a log writing media 200. Further, in the log record writing system, the processing may be performed in accordance with a plurality of transaction processing processes 300.

The log writing means 100, specifically, is implemented by an information processing device such as a personal computer that operates in accordance with a program. Further, the log writing media 200, specifically, is implemented by a storing device such as a magnetic disk device or an optical disk device. Further, the transaction processing process, specifically, is implemented by being processed by a CPU of the information processing device in accordance with the program.

The state keeping means 120 includes a queuing list 121, a completion LSN 122, a request LSN 123, and a lock flag 124. Specifically, the state keeping means 120 stores the data. The log writing control means 110 includes a media writing means 111, a writing completion waiting means 112, a lock release notifying means 114, and a media writing completion notifying means 115.

The above means are roughly operated as described below.

The state keeping means 120 has a function to store values received from a request source in variables of the queuing list 121, the completion LSN 122, the request LSN 123, and lock flag 124 in accordance with the storing request from other means. Further, the state keeping means 120 has a function to extract the values stored in the variables to be output to the request source in accordance with the reading request of the information from other means.

Among the variables, the queuing list 121 is a variable that keeps a pointer to a queue entry. Further, the completion LSN 122 and the request LSN 123 are variables that store the LSNs. Further, the lock flag 124 is a variable that stores two kinds of values that are locked or unlocked.

A queue entry includes three kinds of variables, that is, a pointer to other queue entry, process information, and an LSN and configures a process management queue together with the queuing list 121.

The log writing control means 110 has a function to write a log in accordance with a request from the transaction processing process 300. The log writing control means 110, specifically, is implemented by a CPU of the information processing device that operates in accordance with a program.

The media writing means 111 has a function to perform operation of storing log records from a next LSN of the completion LSN 122 to a requested LSN in the log writing media 200.

It is assumed that when a first transaction processing process 300 allows the media writing means 111 to perform the writing operation of a log record, a second transaction processing process 300 performs the log writing request. In this case, the second transaction processing process 300 allows the writing completion waiting means 112 to wait the completion of the log record writing operation by the first transaction processing process 300. When the log record is completely written in the log writing media 200, the log writing control means 111 allows the media writing completion notifying means 115 to notify the completion of the log writing operation to the first and second transaction processing processes 300.

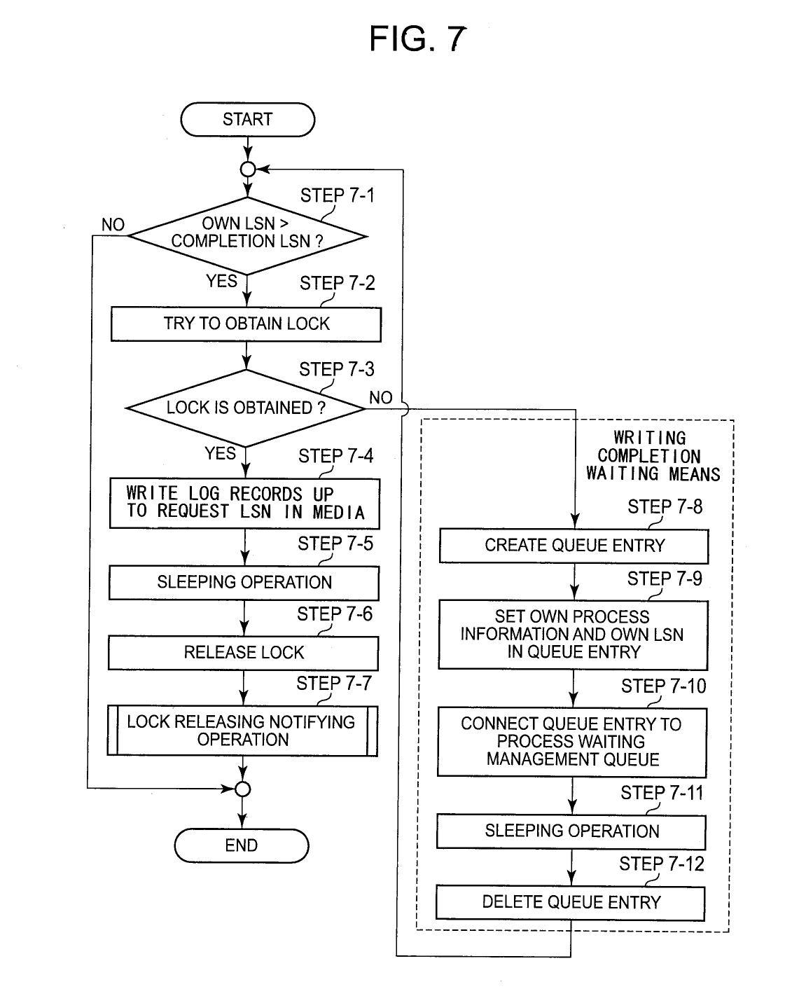

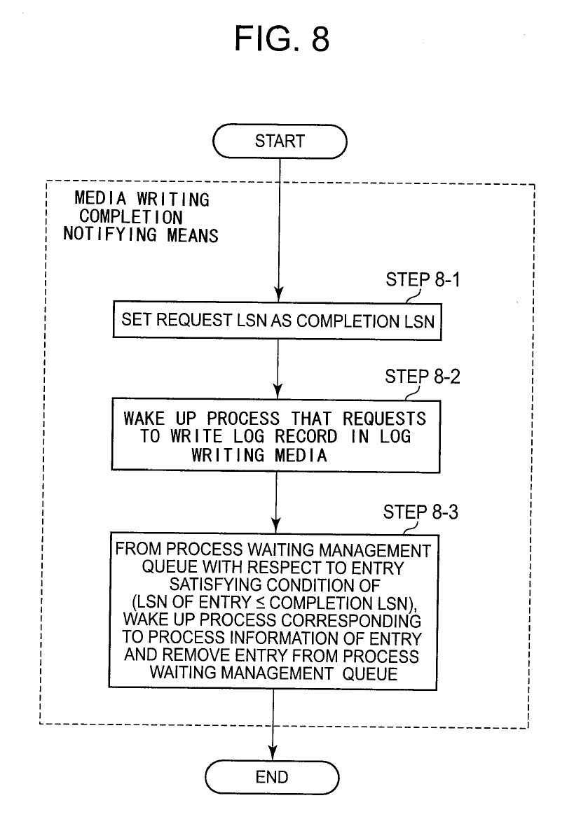

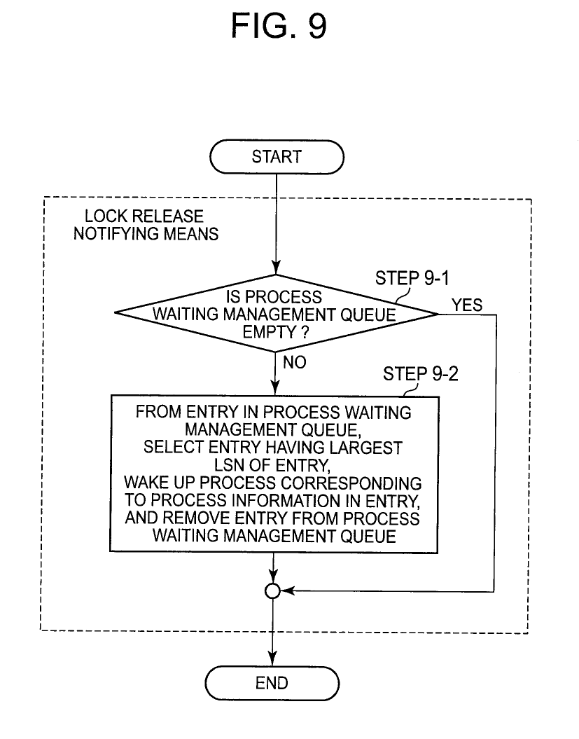

Next, referring to flowcharts of FIGS. 7 to 9, the entire operation of the present exemplary embodiment will be described. FIG. 7 is a flowchart illustrating an operational example of the log writing control means according to this exemplary embodiment. FIG. 8 is a flowchart illustrating an operational example of the media writing completion notifying means according to this exemplary embodiment. FIG. 9 is a flowchart illustrating an operational example of the lock release notifying means according to this exemplary embodiment.

First, the transaction processing process 300 that requests to write a log creates information of the log to be written. The transaction processing process 300 updates the request LSN 123 and associates the updated request LSN 123 with the log record and then starts the log writing control means 110. For example, the transaction processing process 300 associates the updated request LSN 123 with the created log record as a log writing request to output to the log writing control means 110.

The operations so far are the same as the treatment of the log record by a common technology. Hereinafter, the LSN which is associated with the log record created by the above-mentioned transaction processing process 300 is referred to as “own LSN” which indicates that the LSN is the LSN of the transaction processing process 300.

The log writing control means 110 compares the own LSN with the completion LSN 122 (step 7-1 of FIG. 7). As a comparison result, if it is determined that the own LSN is equal to or smaller than the completion LSN 122, this case indicates that the log record is completely written in the log writing media 220, and thus the log writing control means 110 completes the log writing operation.

In contrast, if it is determined that the own LSN is larger than the completion LSN 122, the log writing control means 110 tries to obtain a lock which is managed by the lock flag 124 in the state keeping means 120 (step 7-2) and confirms whether to succeed in obtaining the lock (step 7-3).

A case when it is determined that the lock obtaining operation fails to obtain the lock, that is, the lock has been already obtained by other transaction processing process 300 will be described. This case indicates that the transaction processing process 300 that has obtained the lock performs the writing operation in the log writing media 200. Therefore, the transaction processing process 300 which fails to obtain the lock allows the writing completion waiting means 112 to wait the completion of the writing operation to the log writing media 200.

Specifically, the writing completion waiting means 112 creates a queue entry (step 7-8) and sets information of a own process (that is, the transaction processing process 300 that fails to obtain the lock) and the own LSN in the created queue entry (step 7-9). The writing completion waiting means 112 connects the created queue entry to a process waiting management queue that manages data by a list structure (step 7-10).

Further, in this exemplary embodiment, even though the queue entry is managed using data having a list structure which is a common technology, any data structure may be appropriately used.

After connecting the queue entry to the process waiting management queue, the writing completion waiting means 112 performs a sleeping operation on the transaction processing process 300 (step 7-11). The sleeping state is continued until the transaction processing process 300 is woken up by the writing completion notifying operation by the other transaction processing process 300, as described below.

After the sleeping transaction processing process 300 wakes up and resumes the processing, the writing completion waiting means 112 deletes an unnecessary queue entry (step 7-12). Thereafter, the log writing control means 110 performs the processing again from the first step (step 7-1) of the log writing operation.

In the meantime, a case when the lock is successfully obtained by the lock obtaining operation of step 7-2 will be described. This case indicates that there is no other transaction processing process 300 that performs the writing operation to the media. Therefore, the transaction processing process 300 that successfully obtains the lock requests the log writing to the media writing means 111 to write the log records up to the request LSN 123 in the log writing media 200 (step 7-4) and then sleeps (step 7-5). Specifically, in accordance with the log writing request, the media writing means 111 starts to write the log record in the log writing media 200 and simultaneously performs the sleeping operation on the transaction processing process 300.

When the log writing operation to the log writing media 200 is completed, by the waking-up operation from the media writing completion notifying means 115 which will be described below, the sleeping state of the transaction processing process 300 by step 7-5 is released to resume the processing. When the processing is resumed, in accordance with the request from the transaction processing process 300, the log writing control means 110 releases the lock first (step 7-6) and allows the lock releasing notifying means 114 to wake up the transaction processing process 300 which waits the lock releasing (step 2-7). Specifically, the log writing control means 110 starts the lock release notifying means 114.

The started lock release notifying means 114 checks whether a queue entry remains in the process waiting management queue (step 9-1 of FIG. 9).

If it is determined that the queue entry remains, the lock release notifying means 114 selects a queue entry having the largest LSN among the queue entries connected to the process waiting management queue. The lock release notifying means 114 controls the process corresponding to the process information in the selected queue entry to be woken up by the notification of lock releasing. Thereafter, the lock release notifying means 114 removes the queue entry from the process waiting management queue (step 9-2)

Further, if the writing operation of the log record in the log writing media 200 is completed, the media writing means 111 starts the media writing completion notifying means 115. By doing this, the started media writing completion notifying means 115 sets the request LSN 123 as the completion LSN 122 first (step 8-1 of FIG. 8). The media writing completion notifying means 115 controls the transaction processing process 300, which requests to write the log record in the log writing media 200, to be woken up by the media writing completion notification (step 8-2).

Next, the media writing completion notifying means 115 selects all entries that satisfies the condition that the LSN of the queue entry is equal to or smaller than the completion LSN 122 among the queue entries connected to the process waiting management queue. The media writing completion notifying means 115 wakes up the processes corresponding to the process information included in the selected queue entries. Thereafter, the media writing completion notifying means 115 removes the entry from the process waiting management queue (step 8-3).

Next, an effect of the exemplary embodiment will be described. In this exemplary embodiment, when the plurality of transaction processing processes 300 waits the completion of writing the log record in a sleeping state, the media writing completion notifying means selects all entries that satisfies the condition that the LSN of the queue entry is equal to or smaller than the LSN 122 in which log record is completely written, among the queue entries. The media writing completion notifying means is configured to wake up the process corresponding to the process information included in the selected waiting entries. Therefore, similarly to the first exemplary embodiment, all transaction processing processes 300 that completely write the log record may be woken up by one writing completion notifying operation.

Further, an effect by the lock release notifying means, that is, the effect that, in the subsequent log writing operation, the corresponding log record up to the largest request LSN 123 at the time of operating the writing completion notifying means may be a writing object is the same as the first exemplary embodiment.

Accordingly, in this exemplary embodiment, when the operation of writing the log records of the plurality of processes in the log storing media is completed, the time until the waking-up operation is performed may be shortened. This is because a plurality of processes which are set to entries, each entry having a log sequence number which is equal to or smaller than a log sequence number whose writing is completed becomes objects for waking-up.

Further, in this exemplary embodiment, when the operation of writing the log records of the plurality of processes in the log storing media is completed, it is possible to control to perform the waking-up operation for all processes that completely write the log record. This is because the process that waits the completion of log writing operation connects an entry that sets the information of the log sequence number and information of the own process to the queue so as to select the entries, each entry having the number which is equal to or smaller than a log sequence number whose writing is completed without omission when selecting process which are objects for waking-up.

Further, in this exemplary embodiment, the unit of the log writing operation may be maximized. This is because the process that waits the completion of the log writing operation connects an entry that sets the information of the log sequence number and information of the own process to the queue, and thus, other than the process that completely writes the log, among the processes that do not completely write the log, a process having the largest log sequence number may be selected as an object for waking-up.

As described above, according to this exemplary embodiment, in an information system that outputs a write concerning the storing operation as a log record in order to protect information which has been already stored from disappearing due to the system error in an information system that stores information into a file or a database, the log record concerning storing operation performed by a plurality of processes can be efficiently written all together through one storing operation.

As described above, the present invention relates to a log record writing system, a log record writing device, a log record writing method, and a log record writing program that may efficiently perform the process waking-up operation when the log writing requests from a plurality of processes are written in the log writing media 200 all together through one operation.

A log writing system according to the present invention includes a means of managing a queue having an entry including a log sequence number and the process information as an element. Further, 1) when the process requests the writing operation of the log record, the log writing system connects the entry that stores the log sequence number attached to the log record to be written by the process and its own process information to the queue and makes the process sleep. Further, 2) when the log writing operation in the log storing media is completed, the log writing system searches the queue, and operates to put the plurality of processes set in the entries, each entry having a log sequence number which is equal to or smaller than the log sequence number whose writing is completed and a process whose writing is not completed, a process having the largest log sequence number to objects for waking-up.

With this configuration, the process which is woken up when the log record is completely written is selected so as to obtain the following effects.

A first effect is as follows: when the operation of writing the log records of the plurality of processes in the log storing media is completed, the time until the waking-up operation is performed may be shortened. This is because a plurality of processes which are set to entries, each entry having a log sequence number which is equal to or smaller than a log sequence number whose writing is completed becomes objects for waking-up.

A second effect is as follows: when the operation of writing the log records of the plurality of processes in the log storing media is completed, it is possible to control to perform the waking-up operation for all processes that completely write the log record. This is because the process that waits the completion of log writing operation connects an entry that sets the information of the log sequence number and information of the own process to the queue so as to select the entries having the number which is equal to or smaller than a log sequence number whose writing is completed without omission when selecting processes for waking-up.

A third effect is as follows: the unit of the log writing operation may be maximized. This is because the process that waits the completion of the log writing operation connects an entry that sets the information of the log sequence number and information of the own process to the queue, and thus, other than the process that completely writes the log, among the processes that do not completely write the log, a process having the largest log sequence number may be selected as an objects for waking-up.

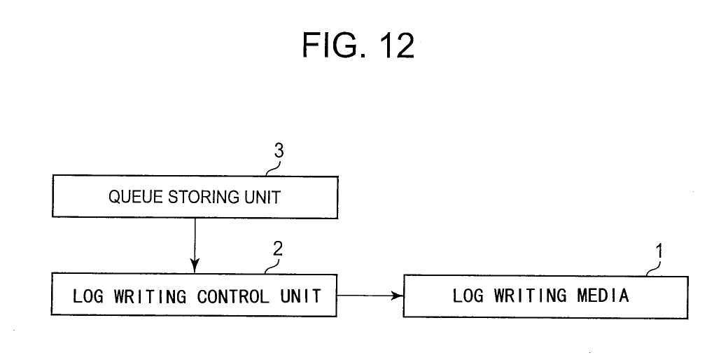

Next, a minimum configuration of a log record writing system according to the present invention will be described. FIG. 12 is a block diagram illustrating a minimum configuration example of the log record writing system. As illustrated in FIG. 12, the log record writing system, as minimum configuration elements, includes a log writing media 1, a log writing control unit 2 that manages the writing operation of the log record according to the log sequence number which is uniquely increased and writes the log record in the log writing media 1, and a queue storing unit 3.

In the log record writing system with the minimum configuration illustrated in FIG. 12, the queue storing unit 3 stores the process waiting management queue which is used so as to select a process which will be an object for the waking-up operation by the completion of writing the log record, among the processes which are waiting the completion of writing the log record in a sleeping state. Further, the queue storing unit 3 includes the log sequence number and information indicating the process in the sleeping state so as to be associated with each other in the queue entry which is an element kept by the process waiting management queue.

When a first process requests to write a log record, if the writing operation of the log record is performed by the other process, the log writing control unit 2 stores the queue entry that sets the log sequence number and the information indicating the first process in the process waiting management queue, with respect to the first process and then allows the first process to be in a sleeping state. When the log record is completely written, the log writing control unit 2 compares the log sequence number included in the queue entry with a log sequence number of the log record which is completely written with respect to the queue entry stored in the process waiting management queue to extract all processes which completely write the log record and wakes up all extracted processes that completely write the logs.

The log record writing system may efficiently perform the operation of writing the log records concerning the storing operation performed by the plurality of processes through one storing operation all together.

Further, the exemplary embodiments have characteristic configuration of the log record writing system as described in the followings (1) to (5).

(1) The log record writing system comprises a log writing media (for example, implemented by a log writing media 200), a log writing control means (for example, implemented by the log writing control means 110) which manages writing operation of log record according to a log sequence number (for example, LSN) which is sequentially increased and writes the log record in the log writing media, and a queue storing means (for example, implemented by the state keeping means 120) which stores a process waiting management queue which is used so as to select a process which is an object for the waking-up operation based on completion of writing the log record, among the processes (for example, implemented by a transaction processing process 300) which are waiting completion of writing the log record in a sleeping state. The queue entries, which are elements of the process waiting management queue, includes information (for example, process information illustrated in FIG. 1) indicating the process in the sleeping state and the log sequence numbers corresponding to the information. When a first process requests to write the log record and the writing operation of the log record is performed by the other process, with respect to the first process, the log writing control means stores the queue entry that sets the log sequence number and the information indicating the first process in the process waiting management queue and then allows the first process to be in a sleeping state (for example, implemented by performing the processing by the writing completion waiting means 112) and then when the log record is completely written, the log writing control means compares the log sequence number (for example, request LSN) included in the queue entry with a log sequence number (for example, completion LSN) of the log record which is completely written with respect to the queue entry stored in the process waiting management queue to extract all processes which completely write the log record and wakes up all extracted processes that completely write the logs (for example, implemented by performing the processing by the writing completion notifying means 113 or the media writing completion notifying means 115).

(2) In the log record writing system, when the log record is completely written, the log writing control means compares the log sequence number included in the queue entry with a log sequence number of the log record which is completely written with respect to the queue entry stored in the process waiting management queue to extract all processes which completely write the log record and wakes up all extracted processes that completely write the logs, and then when the queue entry remains in the process waiting management queue, extracts the queue entry having the largest log sequence number from the remaining queue entries and wakes up the process indicated by the information included in the extracted queue entry.

(3) The log record writing system includes a lock flag storing means (for example, implemented by a state keeping means 120) which stores a lock flag indicating whether the lock is obtained. The log writing control means controls processes so that only the process obtaining the lock starts the writing operation of the log record, controls processes so that the process, which completely writes the log record among the woken-up processes at the time of completion of writing the log record, resumes the operation without performing the lock obtaining operation, controls processes so that the process, which requests to write the log record with the largest log sequence number among the processes that do not completely write the log record, tries to obtain the lock, and starts operation to write the log record on condition that the lock is obtained.

(4) In the log record writing system, when the lock is obtained, the log writing control means writes the log record up to the largest log sequence number in the log writing media.

(5) In the log record writing system, the log writing control means wakes up the process in the sleeping state and simultaneously deletes the queue entry corresponding to the process from the process waiting management queue.

A part or all of the above-described exemplary embodiments may be described like the following supplementary notes, but is not limited thereto.

### (Supplementary Note 1)

A log record writing system including a log writing media, a log writing control means which manages writing operation of a log record according to a log sequence number which is sequentially increased and writes the log record in the log writing media, and a queue storing means which stores a process waiting management queue which is used so as to select a process which is an object for the waking-up operation based on completion of writing the log record, among the processes which are waiting completion of writing the log record in a sleeping state. The queue entries, which are elements of the process waiting management queue, includes information indicating the process in the sleeping state and the log sequence numbers corresponding to the information. When a first process requests to write the log record and the writing operation of the log record is performed by the other process, with respect to the first process, the log writing control means stores the queue entry that sets the log sequence number and the information indicating the first process in the process waiting management queue and then allows the first process to be in a sleeping state and then when the log record is completely written, the log writing control means compares the log sequence number included in the queue entry with a log sequence number of the log record which is completely written with respect to the queue entry stored in the process waiting management queue to extract all processes which completely write the log record and wakes up all extracted processes that completely write the logs. When the log record is completely written, the log writing control means compares the log sequence number included in the queue entry with a log sequence number of the log record which is completely written with respect to the queue entry stored in the process waiting management queue to extract all processes which completely write the log record and wakes up all extracted processes that completely write the logs, and then when the queue entry remains in the process waiting management queue, extracts the queue entry having the largest log sequence number from the remaining queue entries and wakes up the process indicated by the information included in the extracted queue entry.

### (Supplementary Note 2)

The log record writing system described in supplementary note 1 including a lock flag storing means which stores a lock flag indicating whether the lock is obtained. The log writing control means controls processes so that only the process obtaining the lock starts the writing operation of the log record, controls processes so that the process, which completely writes the log record among the woken-up processes at the time of completion of writing the log record, resumes the operation without performing the lock obtaining operation, controls processes so that the process, which requests to write the log record with the largest log sequence number among the processes that do not completely write the log record, tries to obtain the lock, and starts operation to write the log record on condition that the lock is obtained.

### (Supplementary Note 3)

A log record writing method, comprising: storing a process waiting management queue which is used so as to select a process which is an object for the waking-up operation based on completion of writing the log record, among the processes which are waiting completion of writing the log record in a sleeping state, and keeps the queue entries, which are elements of the process waiting management queue, including information indicating the process in the sleeping state and log sequence numbers which are sequentially increased and correspond to the information, when a first process requests to write the log record and the writing operation of the log record is performed by the other process, storing the queue entry that sets the log sequence number and the information indicating the first process in the process waiting management queue with respect to the first process and then allowing the first process to be in a sleeping state and then when the log record is completely written, comparing the log sequence number included in the queue entry with a log sequence number of the log record which is completely written with respect to the queue entry stored in the process waiting management queue to extract all processes which completely write the log record and waking up all extracted processes that completely write the logs, and then when the queue entry remains in the process waiting management queue, extracting the queue entry having the largest log sequence number from the remaining queue entries and waking up the process indicated by the information included in the extracted queue entry.

### (Supplementary Note 4)

The log record writing method described in supplementary note 3, controlling processes so that only the process obtaining the lock starts the writing operation of the log record, controlling processes so that the process, which completely writes the log record among the woken-up processes at the time of completion of writing the log record, resuming the operation without performing the lock obtaining operation, controlling processes so that the process, which requests to write the log record with the largest log sequence number among the processes that do not completely write the log record, trying to obtain the lock, and starting operation to write the log record on condition that the lock is obtained.

### (Supplementary Note 5)

A log record writing program that allows a program that allows a computer, including a storing means which stores a process waiting management queue which is used so as to select a process which is an object for the waking-up operation based on completion of writing the log record, among the processes which are waiting completion of writing the log record in a sleeping state, and keeps the queue entries, which are elements of the process waiting management queue, including information indicating the process in the sleeping state and log sequence numbers which are sequentially increased and correspond to the information, to execute a log writing control processing as follows: when a first process requests to write the log record and the writing operation of the log record is performed by the other process, storing the queue entry that sets the log sequence number and the information indicating the first process in the process waiting management queue with respect to the first process, allowing the first process to be in a sleeping state, when the log record is completely written, comparing the log sequence number included in the queue entry with a log sequence number of the log record which is completely written with respect to the queue entry stored in the process waiting management queue to extract all processes which completely write the log record, and waking up all extracted processes that completely write the logs, and then when the queue entry remains in the process waiting management queue, extracting the queue entry having the largest log sequence number from the remaining queue entries and waking up the process indicated by the information included in the extracted queue entry.

### (Supplementary Note 6)

The log record writing program described in supplementary note 5 that allows the computer, including a lock flag storing means that stores lock flag indicating whether a lock is obtained, to execute controlling processes so that only the process obtaining the lock starts the writing operation of the log record, controlling processes so that the process, which completely writes the log record among the woken-up processes at the time of completion of writing the log record, resuming the operation without performing the lock obtaining operation, controlling processes so that the process, which requests to write the log record with the largest log sequence number among the processes that do not completely write the log record, trying to obtain the lock, and starting operation to write the log record on condition that the lock is obtained.

As described above, the present invention has been described with reference to the examples and the exemplary embodiments, but is not limited to the examples and the exemplary embodiments. Various alternatives and modifications of the configuration or the details of the present invention may be allowed by a person skilled in the art within the scope of the present invention.

This application claims priority to and the benefit of Japanese Patent Application No. 2011-91288 filed in the Japanese Patent Office on Apr. 15, 2011, the entire contents of which are incorporated herein by reference.

### INDUSTRIAL APPLICABILITY

The present invention may be applied to write information concerning storing operation to a file or a database in a media other than the file or the database as a log record.

### REFERENCE SIGNS LIST

1 Log writing media
2 Log writing control unit
3 Queue storing unit
100 Log writing means
110 Log writing control means
111 Media writing means
112 Writing completion waiting means
113 Writing completion notifying means
114 Lock release notifying means
115 Media writing completion notifying means
120 State keeping means
121 Queuing list
122 Completion LSN
123 Request LSN
124 Lock flag
200 Log writing media
300 Transaction processing process

What is claimed is:

1. A log record writing system, comprising:
a log writing media;
a log writing control unit which manages writing operation of a log record according to a log sequence number which is sequentially increased and writes the log record in the log writing media; and
a queue storing unit which stores a process waiting management queue which is used so as to select a process which is an object for the waking-up operation based on completion of writing the log record, among the processes which are waiting for completion of writing the log record in a sleeping state,
wherein the queue entries, which are elements of the process waiting management queue, includes information indicating the process in the sleeping state and the log sequence numbers corresponding to the information, and
when a first process requests to write the log record and the writing operation of the log record is performed by the other process, with respect to the first process, the log writing control unit stores the queue entry that sets the log sequence number and the information indicating the first process in the process waiting management queue and then puts the first process to be in a sleeping state and then when the log record is completely written, the log writing control unit compares the log sequence number included in the queue entry with a log sequence number of the log record which is completely written with respect to the queue entry stored in the process waiting management queue to extract all processes which completely write the log record and wakes up all extracted processes that completely write the logs.

2. The log record writing system according to claim 1, wherein when the log record is completely written, the log writing control unit compares the log sequence number included in the queue entry with a log sequence number of the log record which is completely written with respect to the queue entry stored in the process waiting management queue to extract all processes which completely write the log record and wakes up all extracted processes that completely write the logs, and then when the queue entry remains in the process waiting management queue, extracts the queue entry having the largest log sequence number from the remaining queue entries and wakes up the process indicated by the information included in the extracted queue entry.

3. The log record writing system according to claim 2,
the log writing control unit controls processes so that only the process obtaining the lock starts the writing operation of the log record, controls processes so that the process, which completely writes the log record among the woken-up processes at the time of completion of writing the log record, resumes the operation without performing the lock obtaining operation, controls processes so that the process, which requests to write the log record with the largest log sequence number among the processes that do not completely write the log record, tries to obtain the lock, and starts operation to write the log record on condition that the lock is obtained.

4. The log record writing system according to claim 3, wherein when the lock is obtained, the log writing control unit writes the log record up to the largest log sequence number in the log writing media.

5. The log record writing system according to claim 1 wherein the log writing control unit wakes up the process in the sleeping state and simultaneously deletes the queue entry corresponding to the process from the process waiting management queue.

6. (canceled)

7. A log record writing method, comprising:
storing a process waiting management queue which is used so as to select a process which is an object for the waking-up operation based on completion of writing a log record, among the processes which are waiting for completion of writing the log record in a sleeping state, and keeps the queue entries, which are elements of the process waiting management queue, including information indicating the process in the sleeping state and log sequence numbers which are sequentially increased and correspond to the information;
when a first process requests to write the log record and the writing operation of the log record is performed by the other process, storing the queue entry that sets the log sequence number and the information indicating the first process in the process waiting management queue with respect to the first process and then putting the first process to be in a sleeping state and then when the log record is completely written, comparing the log sequence number included in the queue entry with a log sequence number of the log record which is completely written with respect to the queue entry stored in the process waiting management queue to extract all processes which completely write the log record and waking up all extracted processes that completely write the logs.

8. A computer readable information recording medium storing a log record writing program for a processor including a storing unit which stores a process waiting management queue which is used so as to select a process which is an object for the waking-up operation based on completion of writing a log record, among the processes which are waiting for completion of writing the log record in a sleeping state, and keeps the queue entries, which are elements of the process waiting management queue, including information indicating the process in the sleeping state and log sequence numbers which are sequentially increased and correspond to the information, when executed:
when a first process requests to write the log record and the writing operation of the log record is performed by the other process, storing the queue entry that sets the log sequence number and the information indicating the first process in the process waiting management queue with respect to the first process, putting the first process to be in a sleeping state, when the log record is completely written, comparing the log sequence number included in the queue entry with a log sequence number of the log record which is completely written with respect to the queue entry stored in the process waiting management queue to extract all processes which completely write the log record, and waking up all extracted processes that completely write the logs.
